(19) United States
(12) Patent Application Publication
(10) Pub. No.: US 2024/0370778 A1
(43) Pub. Date: Nov. 7, 2024

(54) SYSTEM AND METHOD FOR UPDATING PREDICTION MODEL FOR CURING PROCESS DESIGN

(71) Applicant: Quantiphi, Inc., Marlborough, MA (US)

(72) Inventors: Dagnachew Birru, Marlborough, MA (US); Anirudh Deodhar, Mumbai (IN); Milad Ramezankhani, Toronto (CA); Rishi Yash Parekh, Mumbai (IN)

(73) Assignee: Quantiphi, Inc, Marlborough, MA (US)

(21) Appl. No.: 18/766,746

(22) Filed: Jul. 9, 2024

(51) Int. Cl. G06N 20/00; G06N 5/022

(52) U.S. Cl. CPC G06N 20/00; G06N 5/022

(57) ABSTRACT

A method and system for updating prediction model for curing process design is disclosed. The method includes updating a prediction model based on the input through a semi-supervised learning technique. The method may include receiving an input corresponding to a curing process. The method may further include generating a second set of experiments using the updated prediction model and an optimization component associated with the prediction model. The method may further include obtaining a second set of data upon performing a second set of experiments on a physical set-up. The method may further include determining an error between the predicted set of data and the second set of data. The method may further include updating the prediction model based on the second set of data when the error is out of a predefined threshold.

### FIELD OF THE INVENTION

The present disclosure relates to manufacturing processes, and more specifically to a method and system for updating prediction model for curing process design.

### BACKGROUND OF THE INVENTION

The curing process in composite material manufacturing is critical as it determines mechanical properties and performance of a final product. Manufacturing of composite materials, particularly the curing process, is a complex and expertise-intensive task. Traditional methods for designing curing processes involve a combination of first-principles modeling, empirical experimentation, and iterative adjustments based on experimental feedback. These methods, however, face several limitations:

First-Principles Modeling: While valuable, first-principles models are often limited in their ability to capture the full complexity of curing processes. It require extensive domain expertise and may struggle to accurately predict outcomes under varying conditions.

Pure Data-Driven Approaches: Data-driven models rely heavily on historical data and are typically condition-specific. These approaches lack the flexibility to generalize across different scenarios and often fail when extrapolating beyond the range of their training data.

Hybrid Models (e.g., PINNs): Hybrid approaches, such as Physics-Informed Neural Networks (PINNs), combine the strengths of first principles and data-driven methods. However, these methods still face challenges, particularly in predicting parameters outside their training range and adapting to real-time, dynamic conditions.

Experiment-Driven Design: Designing experiments and utilizing the resulting data traditionally requires significant human expertise. This process is time-consuming and prolongs the design cycle. Additionally, the nature of these models makes it difficult to implement ‘online’ designing processes, where real-time updates and adjustments are crucial.

The traditional methods of designing curing processes rely heavily on human expertise and conventional numerical methods, which are time-consuming and often suboptimal. Therefore, there is a need for a method and system that may iteratively update hybrid designer with knowledge-driven experiments for curing process design, minimizing human intervention and accelerating the design cycle.

### SUMMARY

The following embodiments presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

Some example embodiments disclosed herein provide computer-implemented method for updating prediction model for curing process design, the method may include receiving an input corresponding to a curing process. The method may further include updating a prediction model based on the input through a semi-supervised learning technique. The method may further include generating a second set of experiments using the updated prediction model and an optimization component associated with the prediction model. The method may further include obtaining a second set of data. The second set of data may be obtained by performing a second set of experiments on physical set-up. The method may further include determining an error between the predicted set of data and the second set of data. The method may further include updating the prediction model based on the second set of data when the error is out of a predefined threshold, the prediction model is updated iteratively until the error is within the predefined threshold.

According to some example embodiments, wherein the prediction model is a physics informed neural operator (PINO) model.

According to some example embodiments, wherein the input comprises a task to design the curing process, and a plurality of system parameters.

According to some example embodiments, the method further comprising identifying a change in material specification upon receiving the task, wherein the identification is at least one of a successful identification or an unsuccessful identification.

According to some example embodiments, the method further comprising when the identification is the unsuccessful identification, generating a first set of experiments through an experiment designer using a predefined design of experiments (DOE) approach, based on the input, wherein the first set of experiments are generated before generating the second set of experiments, and updating the prediction model based on the first set of experiments.

According to some example embodiments, the method further comprising when the identification is the successful identification, determining an availability of curing coefficients from material characterization tests

According to some example embodiments, the method further comprising, when the curing coefficients are available, generating the second set of experiments using the curing coefficients through the prediction model and the optimization component.

According to some example embodiments, the method further comprising when the curing coefficients are unavailable, obtaining the task and the material specifications, generating a third set of experiments through the experiment designer using the predefined design of experiments (DOE) approach, based on the material specifications, for the task, obtaining a third set of data upon performing the third set of experiments on the physical set-up, updating the prediction model based on the third set of data using a curing coefficient estimator, wherein the curing coefficient estimator is configured to estimate material specifications and corresponding behavior, and generating the first set of experiments using the curing coefficients through the updated prediction model and the optimization component.

According to some example embodiments, the method further comprising generating a final set of experiments when the error between the predicted set of data and the second set of data is within the predefined threshold.

According to some example embodiments, wherein when the error is out of the predefined threshold, the prediction model is further trained to adjust noise and uncertainties in the plurality of system parameters.

Some example embodiments disclosed herein provide a computer-implemented system for updating prediction model for curing process design. The computer-implemented system includes a memory, and a processor communicatively coupled the memory, configured to receive an input corresponding to a curing process. The processor further configured to update a prediction model based on the input through a semi-supervised learning technique. The processor further configured to generate a second set of experiments using the updated prediction model and an optimization component associated with the prediction model. The processor further configured to obtain a second set of data. The second set of data may be obtained by performing a second set of experiments on physical set-up. The processor further configured to determine an error between the predicted set of data and the second set of data. The processor further configured to update the prediction model based on the second set of data when the error is out of a predefined threshold.

Some example embodiments disclosed herein provide a non-transitory computer readable medium having stored thereon computer executable instruction which when executed by one or more processors, cause the one or more processors to carry out operations for updating prediction model for curing process design, the operations comprising receiving an input corresponding to a curing process. The operations further comprising updating a prediction model based on the input through a semi-supervised learning technique. The operations further comprising generating a second set of experiments using the updated prediction model and an optimization component associated with the prediction model. The operations further comprising obtaining a second set of data upon performing the second set of experiments on a physical set-up. The operations further comprising determining an error between the predicted set of data and the second set of data. The operations further comprising updating the prediction model based on the second set of data when the error is out of a predefined threshold.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The above and still further example embodiments of the present invention will become apparent upon consideration of the following detailed description of embodiments thereof, especially when taken in conjunction with the accompanying drawings, and wherein:

FIG. 1 is a block diagram of an environment of a system for updating prediction model for curing process design, in accordance with an example embodiment.

FIG. 2 is a block diagram illustrating various modules within a memory of a computing device configured for updating prediction model for curing process design, in accordance with an example embodiment.

FIG. 3 illustrates a flow diagram of a method for updating prediction model for curing process design, in accordance with an example embodiment.

FIG. 4 illustrates a flow diagram of a method for generating a final set of experiments, in accordance with an example embodiment.

FIG. 5 illustrates an exemplary flow diagram of a method for updating prediction model for curing process design, in accordance with an example embodiment.

FIG. 6 illustrates a flow diagram of a method for generating a second set of experiments when the curing coefficients are available, in accordance with an example embodiment

FIG. 7 illustrates a flow diagram of a method for generating a second set of experiments when the curing coefficients are unavailable, in accordance with an example embodiment.

FIGS. 8A and 8B illustrate an exemplary flow chart for updating prediction model for curing process design, in accordance with an example embodiment.

FIG. 9A illustrates an exemplary autoclave setup for composite material, in accordance with an example embodiment.

FIG. 9B illustrates a corresponding temperature and degree of cure profiles over time for the autoclave setup, in accordance with an example embodiment.

The figures illustrate embodiments of the invention for purposes of illustration only. One skilled in the art will readily recognize from the following description that alternative embodiments of the structures and methods illustrated herein may be employed without departing from the principles of the invention described herein.

### DETAILED DESCRIPTION

In the following description, for purposes of explanation, numerous specific details are set forth in order to provide a thorough understanding of the present invention. It will be apparent, however, to one skilled in the art that the present invention can be practiced without these specific details. In other instances, systems, apparatuses, and methods are shown in block diagram form only in order to avoid obscuring the present invention.

Reference in this specification to “one embodiment” or “an embodiment” or “example embodiment” means that a particular feature, structure, or characteristic described in connection with the embodiment is included in at least one embodiment of the present invention. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

The terms “comprise”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, non-volatile memory, hard drives, CD ROMs, DVDs, flash drives, disks, and any other known physical storage media.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present invention. Further, it is to be understood that the phraseology and terminology employed herein are for the purpose of the description and should not be regarded as limiting. Any heading utilized within this description is for convenience only and has no legal or limiting effect.

### Definitions

The term “Physics-Informed Neural Operators (PINOs)” may represent a type of machine learning framework that combines principles from physics with neural network architectures, for mapping relationships between functional spaces. These PINOs are utilized for modeling complex systems, particularly those characterized by nonlinear dynamics, long temporal domains, and discontinuities.

The term “machine learning model” may be used to refer to a computational or statistical or mathematical model that is trained on classical ML modelling techniques with or without classical image processing. The “machine learning model” is trained over a set of data and using an algorithm that it may be used to learn from the dataset.

The term “artificial intelligence” may be used to refer to a model built using simple or complex Neural Networks using deep learning techniques and computer vision algorithms. Artificial intelligence model learns from the data and applies that learning to achieve specific pre-defined objectives.

The term “module” used herein may refer to a hardware processor including a Central Processing Unit (CPU), an Application-Specific Integrated Circuit (ASIC), an Application-Specific Instruction-Set Processor (ASIP), a Graphics Processing Unit (GPU), a Physics Processing Unit (PPU), a Digital Signal Processor (DSP), a Field Programmable Gate Array (FPGA), a Programmable Logic Device (PLD), a Controller, a Microcontroller unit, a Processor, a Microprocessor, an ARM, or the like, or any combination thereof.

### End of Definitions

As described earlier, traditional methods of designing curing processes rely heavily on human expertise and conventional numerical methods, which are time-consuming and often suboptimal. The present disclosure addresses these challenges by introducing a method and system for updating prediction model for curing process design. The proposed method and system uses pre-trained and dynamically adaptable Hybrid (physics-informed and data-driven) neural operators coupled with optimizer for effective knowledge and data-driven design generation, testing and evaluation. Further, the proposed method and system iteratively update hybrid neural operators or prediction model with knowledge-driven experiments for curing process design, minimizing human intervention and accelerating the design cycle.

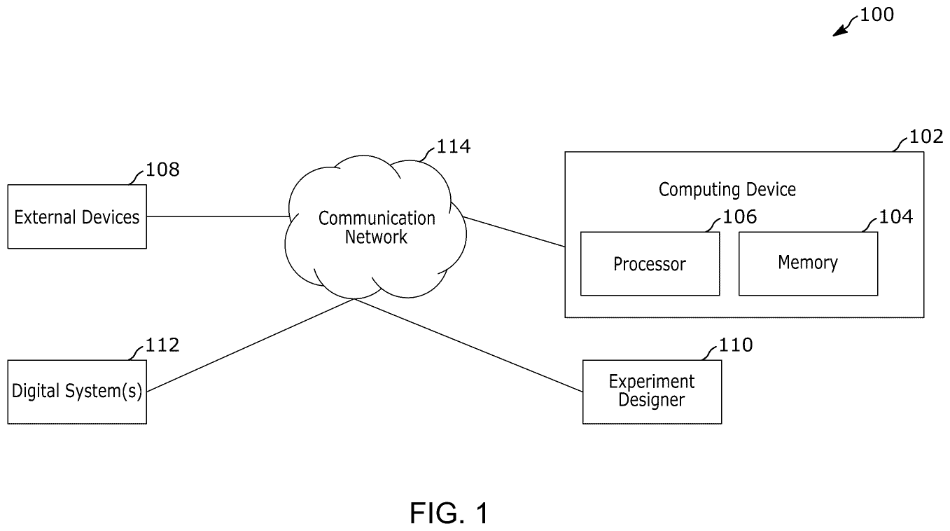

Embodiments of the present disclosure may provide a method, a system, and a computer program product for updating prediction model for curing process design. The method, the system, and the computer program product update prediction model for curing process design in such an improved manner are described with reference to FIG. 1 to FIG. 9 as detailed below.

FIG. 1 illustrates a block diagram of an environment of a system 100 for updating prediction model for curing process design, in accordance with an example embodiment. The system 100 is designed to facilitate efficient and accurate design of curing processes by utilizing advanced computational techniques and automated experiment design. The system 100 includes a computing device 102, external devices 108, experiment designer 110 and digital system(s) 112. The computing device 102 may be communicatively coupled with one of the external devices 108, experiment designer 110 and digital system(s) 112 via a communication network 114. Examples of the computing device 102 may include, but are not limited to, a server, a desktop, a laptop, a notebook, a tablet, a smartphone, a mobile phone, an application server, or the like.

The communication network 112 may be wired, wireless, or any combination of wired and wireless communication networks, such as cellular, Wi-Fi, internet, local area networks, or the like. In one embodiment, the network 112 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

The computing device 102 may include a memory 104, and a processor 106. The term “memory” used herein may refer to any computer-readable storage medium, for example, volatile memory, random access memory (RAM), non-volatile memory, read only memory (ROM), or flash memory. The memory 104 may include a Random-Access Memory (RAM), a Read-Only Memory (ROM), a Complementary Metal Oxide Semiconductor Memory (CMOS), a magnetic surface memory, a Hard Disk Drive (HDD), a floppy disk, a magnetic tape, a disc (CD-ROM, DVD-ROM, etc.), a USB Flash Drive (UFD), or the like, or any combination thereof.

The term “processor” used herein may refer to a hardware processor including a Central Processing Unit (CPU), an Application-Specific Integrated Circuit (ASIC), an Application-Specific Instruction-Set Processor (ASIP), a Graphics Processing Unit (GPU), a Physics Processing Unit (PPU), a Digital Signal Processor (DSP), a Field Programmable Gate Array (FPGA), a Programmable Logic Device (PLD), a Controller, a Microcontroller unit, a Processor, a Microprocessor, an ARM, or the like, or any combination thereof.

The processor 106 may retrieve computer program code instructions that may be stored in the memory 104 for execution of the computer program code instructions. The processor 106 may be embodied in a number of different ways. For example, the processor 106 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 106 may include one or more processing cores configured to perform independently. A multi-core processor may enable multiprocessing within a single physical package. Additionally, or alternatively, the processor 106 may include one or more processors configured in tandem via the bus to enable independent execution of instructions, pipelining, and/or multithreading.

Additionally, or alternatively, the processor 106 may include one or more processors capable of processing large volumes of workloads and operations to provide support for big data analysis. In an example embodiment, the processor 106 may be in communication with a memory 104 via a bus for passing information among components of the system 100.

The memory 104 may be non-transitory and may include, for example, one or more volatile and/or non-volatile memories. In other words, for example, the memory 104 may be an electronic storage device (for example, a computer readable storage medium) comprising gates configured to store data (for example, bits) that may be retrievable by a machine (for example, a computing device like the processor 106). The memory 104 may be configured to store information, data, contents, applications, instructions, or the like, for enabling the apparatus to carry out various functions in accordance with an example embodiment of the present disclosure. For example, the memory 104 may be configured to buffer input data for processing by the processor 106.

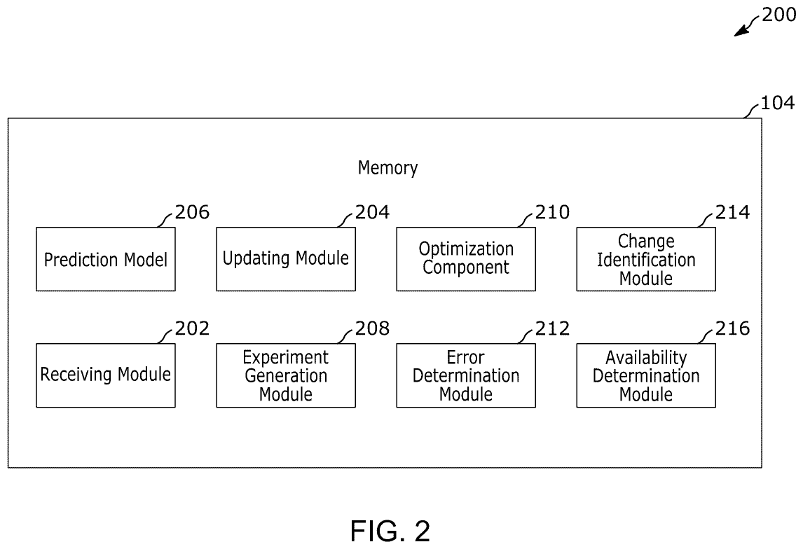

The computing device 102 may be capable of updating the prediction model for curing process design. The memory 104 may store instructions that, when executed by the processor 106, cause the computing device 102 to perform one or more operations of the present disclosure which will be described in greater detail in conjunction with FIG. 2. The computing device 102 is responsible for performing tasks such as receiving input corresponding to a curing process, updating the prediction model using a semi-supervised learning technique, generating experiments based on the updated model, and optimizing the curing process. The computing device 102 continually learns and updates the prediction model in real-time based on incoming data from these experiments, ensuring that the optimization component iteratively improves the curing process using feedback from both simulations and real-world experiments.

The external devices 108 may refers to various hardware and software tools that may be integrated with the system 100 to enhance its functionality. These devices may include sensors, actuators, and other measurement instruments that provide real-time data from the curing process. For example, temperature sensors, humidity sensors, and pressure sensors may feed critical process parameters back to the computing device 102. This real-time data is essential for the continual learning framework to make accurate updates to the prediction model and ensure the optimization component may refine the curing process effectively.

The experiment designer 110 is a crucial component of the system 100, responsible for generating both the initial and subsequent sets of experiments. It uses predefined design of experiments (DOE) approaches, such as the Taguchi method, to create structured experimental plans. The experiment designer 110 utilizes a large language model (LLM) to optimize these plans further, generating structured prompts tailored to the specific requirements of the curing process. This ensures that the experiments are designed efficiently and effectively, reducing dependency on human expertise, and accelerating the overall design cycle. The experiment designer 110 interacts with the computing device 102 to generate experiments, gather data, and update the prediction model based on the results, thereby continually refining the curing process design.

The digital system(s) 112 encompass various computational and analytical tools that support the operation of the system 100. These digital systems may include digital twins, simulation platforms, and data analytics tools that provide a virtual representation of the curing process. The digital systems 112 enable in vitro experimentation, allowing for the testing and validation of different curing scenarios without physical trials. This capability is essential for optimizing the curing process in a cost-effective and time-efficient manner. The digital systems 112 work in tandem with the computing device 102 to ensure seamless integration and data flow. The complete process followed by the system 100 is explained in detail in conjunction with FIG. 2 to FIG. 10.

FIG. 2 illustrates a block diagram 200 illustrating various modules within the memory 104 of the computing device 102 configured for updating prediction models for curing process design, in accordance with an example embodiment. The memory 104 may include a receiving module 202, an updating module 204, a prediction model 206, an experiment generation module 208, an optimization component 210, an error determination module 212, a change identification module 214, and an availability determination module 216.

The receiving module 202 is responsible for receiving input data corresponding to the curing process. The input data may include a task to design the curing process and a plurality of system parameters. The task is crucial as it sets the goals and constraints for the curing process. This task may include various objectives such as optimizing curing time, improving material properties, or achieving uniform curing. Further, the design task often comes with specific parameters that need to be followed. These parameters may include type of material being cured, desired mechanical properties, environmental conditions, and any industry-specific standards or regulations. Additionally, the system parameters include detailed material specifications such as chemical composition, thermal properties, and physical characteristics of the materials involved in the curing process. For example, such as material properties (conductivity, curing coefficient), environmental parameters (heat transfer coefficient) These specifications are critical for the prediction model to make accurate predictions about the curing outcomes. The receiving module 202 ensures that the computing device 102 has the latest and most accurate data necessary to update the prediction model.

The updating module 204 is configured to update the prediction model using a semi-supervised learning technique. The updating module 204 utilizes the input data received from the receiving module 202 to refine and enhance the accuracy of the prediction model. The prediction model learns from a knowledge of ideal experiments and updates itself using just the input parameters first. The updating module 204 iteratively updates both virtual and real design optimizations for curing composite materials. In vitro and in vivo models are combined to enhance the prediction model's accuracy and reliability. The automatic and iterative update of the prediction model is facilitated by knowledge-driven experiments and on-field experimental data iteratively. The semi-supervised learning approach combines labeled and unlabeled data, allowing the prediction model to improve its predictions even with limited labeled data. In some embodiments, unsupervised update may be performed on the prediction model using only the inputs specific to generated experiments (no real data specific to output).

The prediction model 206 is responsible for making real-time predictions about the curing process under dynamic conditions based on the input data and updated parameters. The dynamic conditions refer to varying parameters in the manufacturing environment, such as changes in temperature, pressure, humidity, material properties, and other external factors that may influence the curing process. The prediction model 206 is designed to account for these variations and provide accurate predictions regardless of these fluctuations. Specifically, the prediction model 206 is a physics-informed neural operator (PINO) model. This model integrates physics-based simulations with real-world experimental data to provide accurate and reliable predictions. The real-world experimental data encompasses empirical measurements and observations collected from actual manufacturing processes, including temperature profiles, pressure readings, material behavior, and curing times. The prediction model 206 is continually refined by the updating module 204 to ensure high accuracy and reliability in dynamic conditions.

Once the prediction model 206 is updated, the experiment generation module 208 is configured for generating experiments. In particular, the experiment generation module 208 generates a first set of experiments. The first set of experiments has a first set of data. The first set of experiments refers to an initial batch of experiments generated by the experiment generation module 208. These experiments are designed using the updated prediction model and the optimization component 210 associated with the prediction model 206. The first set of data include all the measurements, observations, and results obtained from conducting the first set of experiments. For example, the first set of data may include, but is not limited to, inputs material, dimensions, operating conditions, and the model predictions of temperature and curing degree. This data is multi-faceted and includes various parameters and outcomes that are critical for understanding the curing process. This may include temperature profiles, pressure levels, humidity, curing time, and any other relevant process parameters that are controlled or measured during the experiments. The experiments are designed using established design of experiments (DOE) methodologies, such as factorial designs, response surface methodology (RSM), or Taguchi methods.

After generating the first set of experiments and collecting the first set of data, the experiment generation module 208 may obtain a second set of data upon performing second set experiments on a physical set. The second set of data may be the experimental values of inputs material, dimensions and operating conditions, and outputs. This physical setup may include actual manufacturing equipment, sensors, and materials used in the curing process, ensuring that the data collected reflects real-world conditions and challenges. The second set of data further validate and update the prediction model, ensuring its accuracy under real-world conditions. In some embodiments, supervised update may be performed on the prediction model using data generated and measured from the real experiments.

The error determination module 212 evaluates the performance of the prediction model 206 by identifying discrepancies between the predicted outcomes and the actual results of the curing process. It compares the predicted data from the second set of experiments (the predicted set of data) with the real-world results obtained from performing those experiments (the second set of data). To further elaborate, the error determination module 212 receives the predicted set of data generated from the prediction model 206 and the second set of experiments. The error determination module 212 also receives the second set of data obtained from the actual physical experiments performed based on the second set of experiments. Further, the error determination module 212 calculates the error by comparing corresponding data points from the predicted and second sets of data. This module compares the calculated error against predefined thresholds to determine the acceptability of the prediction model's performance. These thresholds are established based on industry standards, material specifications, and desired quality levels for the curing process. Various statistical and analytical methods may be used for this comparison, such as:
Mean Squared Error (MSE): Calculating the average of the squares of the differences between predicted and actual values.
Root Mean Squared Error (RMSE): Taking the square root of the MSE for easier interpretation of error magnitude.
Absolute Error: The absolute difference between predicted and actual values.
Relative Error: The error as a percentage of the actual value, providing context on the significance of the error

Upon determining the error and detecting that the error is out of the predefined threshold, the updating Module 204 integrates the second set of data into the model's training dataset. The second set of data includes the actual results from the physical experiments, reflecting real-world conditions and material behaviors. The updated prediction model provides a solid foundation for data-driven decision making, allowing for informed adjustments and refinements in the curing process design. When the error is out of the predefined threshold, the prediction model 206 is further trained to adjust noise and uncertainties in the plurality of system parameters, ensuring that the model remains robust and reliable. This involves filtering out anomalies and accounting for variations in the experimental setup that may affect the results.

If the error falls within the predefined threshold, this indicates that an accuracy of the prediction model is satisfactory and that the model's predictions align well with the actual experimental outcomes. In such cases, the experiment generation module 208 proceeds to generate a final set of experiments. This step is essential for confirming the robustness and reliability of the prediction model 206 under varied conditions and potentially different parameter settings. The final set of experiments is designed to validate the prediction model 206 further and to fine-tune the curing process parameters to ensure optimal performance and quality.

These final experiments are executed to confirm that the prediction model 206 may consistently produce accurate and reliable results, ensuring that the curing process design is robust and efficient. The data obtained from these final experiments is used to make any last adjustments to the process parameters, ensuring that the final curing process design is both optimized and validated. This validation step is crucial for ensuring the high quality and reliability of the final product, minimizing errors and defects, and ensuring that the curing process meets all desired specifications and industry standards. The optimization objective is to attain the best curing degree or curve. The constraints are physics-related properties, and decision variables are material composition, dimension, and air temperature, which are bounded by a range. Genetic Algorithms or linear programming is used for the optimization.

The change identification module 214 is responsible for detecting any changes in the material specifications upon receiving a new task for the curing process design. This module analyzes the input, which includes system parameters and tasks, to determine if there are any changes in the materials used. It categorizes the identification as either successful or unsuccessful based on the analysis.

When the change identification module 214 classifies the identification as unsuccessful, it triggers the experiment generation module 208 to create a second set of experiments using a predefined DOE approach. These experiments are designed to gather additional data needed to update the prediction model 206 accurately. The prediction model 206 is then updated based on the data obtained from these second set of experiments, ensuring that it may handle the identified material changes effectively.

If the change identification module 214 categorizes the identification as successful, the system then relies on the availability determination module 216. This module checks if the curing coefficients, which are critical parameters derived from material characterization tests, are available. The prediction model is used for solving inverse problem using the experimental data and physics for estimating curing coefficient.

When the curing coefficients are available, the experiment generation module 208 uses these coefficients along with the prediction model 206 and the optimization component 210 to generate the second set of experiments. This ensures that the experiments are based on accurate material parameters, leading to more reliable and optimized curing processes.

If the curing coefficients are unavailable, the system needs to generate and perform additional experiments to estimate these coefficients. The experiment generation module 208, guided by the experiment designer, uses the predefined DOE approach based on the provided material specifications to create a third set of experiments. These experiments are then conducted on a physical setup, and the resulting data (third set of data) is fed back into the system. The system generates knowledge-driven experiments, updates the model on the go, and improves the model by generating better experiments and real data.

The curing coefficient estimator, which is a specialized tool for estimating material behavior and specifications, uses this data to estimate the missing curing coefficients. Once these coefficients are estimated, the prediction model 206 is updated accordingly. The experiment generation module 208 then uses the updated prediction model and the optimization component 210 to generate the second set of experiments, ensuring they are based on accurate and updated material parameters.

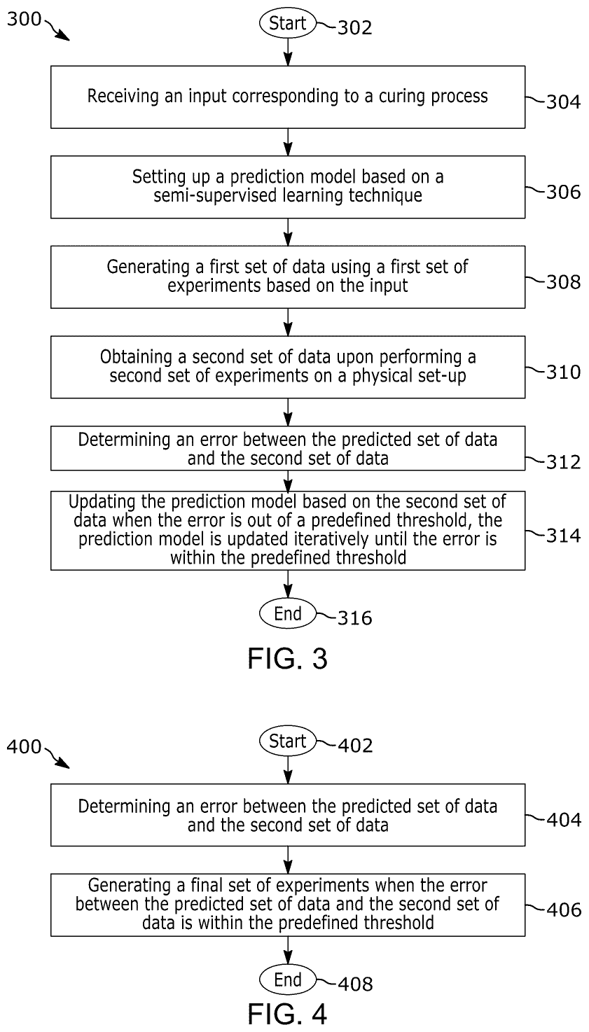

FIG. 3 illustrates a flow diagram of a method 300 for updating prediction model for curing process design, in accordance with an example embodiment. It will be understood that each block of the flow diagram of the method 300 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 104 of the computing device 102, employing an embodiment of the present disclosure and executed by a processor 106. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

The method 300 illustrated by the flow diagram of FIG. 3 for updating prediction model for curing process design may start at step 302. Further, the method 300 may include receiving an input corresponding to a curing process, at step 304. The input may include a task to design the curing process, and a plurality of system parameters that define the operational constraints and characteristics of the materials involved. The task to design the curing process might specify objectives such as optimizing the curing time, improving the mechanical properties of the material, or ensuring uniform curing throughout the material. The system parameters may include factors like the type of resin used, the dimensions of the composite parts, the desired curing profile, environmental conditions like temperature and humidity, and any other relevant material properties. These inputs are critical for informing the prediction model and guiding the subsequent steps in the optimization process.

The method 300, at step 306, may include setting up a prediction model based on the input through a semi-supervised learning technique. This approach utilizes both labeled and unlabeled data to refine the prediction model accuracy and predictive capabilities. Unlike conventional semi-supervised techniques, the disclosed semi-supervised learning technique deals with scenarios where only the input parameters are known, but the actual output data is not available. The known physical principles of the curing process play a crucial role in guiding the learning process and refining the prediction model. This hybrid approach allows the system to make informed predictions even in the absence of complete labeled data, thereby improving the model's robustness and applicability in real-world scenarios. By incorporating both types of data, the model may improve its predictions even with limited labeled data. The updating process involves integrating new data points into the existing model framework, adjusting model parameters, and recalibrating the model to better fit the observed data. This continuous learning process ensures that the model remains current and accurate, adapting to new information as it becomes available.

The prediction model used is a Physics Informed Neural Operator (PINO) model. This model utilizes both physics-based principles and data-driven approaches to make accurate predictions under varying conditions. The PINO model is capable of real-time predictions, providing information of how the curing process may evolve based on current and expected conditions.

At step 308, the method 300 may include, generating a first set of data using a first set of experiments. These experiments are designed to explore various scenarios and conditions under which the curing process may operate. First set of experiments may be generated through an experiment designer using a predefined DOE approach. The first set of experiments is carefully crafted to cover a broad range of conditions and parameters, providing a comprehensive dataset for further analysis. These experiments are expected to yield a first set of data that captures the outcomes and behaviors of the curing process under different conditions. This data includes measurements such as temperature profiles, curing times, mechanical properties of the cured material, and any other relevant metrics. Alternatively, in some embodiments, the first set of data may include, but is not limited to, inputs material, dimensions, operating conditions, and the model predictions of temperature and curing degree.

At step 310, the method 300 may include, obtaining a second set of data. This step is critical for validating the predictions made by the model. By conducting real-world experiments, the method 300 gathers data that reflects actual material behaviors and environmental interactions. The physical setup includes all necessary equipment and materials to replicate the curing process as closely as possible to real-world conditions. The second set of data collected from these experiments provides a basis for comparison with the model predictions, highlighting any discrepancies and areas for improvement. The second set of data may be the experimental values of inputs material, dimensions and operating conditions, and outputs.

At step 312, the method 300 may include, determining an error between the predicted set of data (predicted by the prediction model using the second set of experiments) and the second set of data (obtained from physical experiments using the second set of experiments). This error quantification is essential for assessing the prediction model accuracy and identifying any deviations between predicted and actual outcomes. Various statistical and analytical techniques may be employed to calculate this error, such as mean squared error (MSE), root mean squared error (RMSE), or absolute error. By comparing the predicted data with the actual experimental results, the method 300 identifies specific areas where the model predictions deviate from real-world observations.

At step 314, the method 300 may include, updating the prediction model based on the second set of data, particularly when the error is out of a predefined threshold. The prediction model is updated iteratively until the error is within the predefined threshold. If the error exceeds acceptable limits, it indicates that the model's predictions are not sufficiently accurate. In response, the model undergoes further refinement and retraining using the new data obtained from the physical experiments. This process involves adjusting the model parameters, incorporating additional data points, and potentially modifying the model's structure to better align with observed behaviors. The goal is to minimize the error and enhance the model's predictive accuracy. Further, the method 300 terminated at step 316.

FIG. 4 illustrates a flow diagram of a method 400 for generating a final set of experiments, in accordance with an example embodiment. It will be understood that each block of the flow diagram of the method 400 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 104 of the computing device 102, employing an embodiment of the present disclosure and executed by a processor 106. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

FIG. 4 is explained in conjunction with elements from FIGS. 1, 2, and 3. At step 402, the method 400 is initiated. The method 400, at step 404 may include determining an error between the predicted set of data predicted by the updated prediction model and the second set of data (obtained by carrying out a second set of experiments on physical set up)). The error analysis helps identify how well the model predictions align with the real-world outcomes and highlights any areas where the model may need further refinement.

Further, the method 400, at step 406, may include generating a final set of experiments when the error between the predicted set of data and the second set of data is within the predefined threshold. The final set of experiments is designed to further validate and fine-tune the curing process parameters, ensuring that the process design is both optimized and robust. These experiments aim to confirm the reliability of the prediction model under varied conditions and potentially different parameter settings. By generating and conducting these final experiments, the method ensures that the curing process meets all desired specifications and industry standards, resulting in high-quality and reliable outcomes. The method 400 ends at step 408.

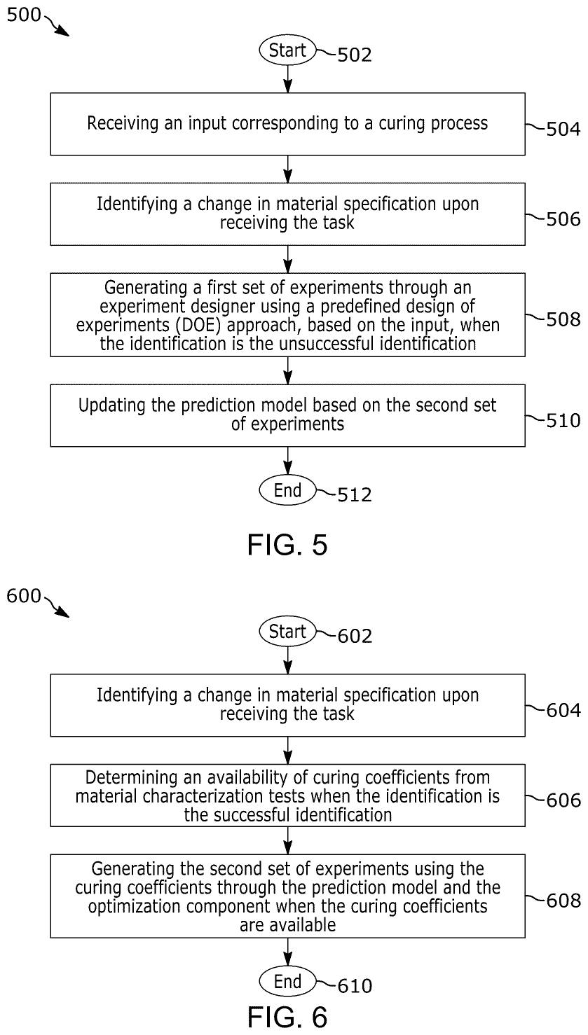

FIG. 5 illustrates an exemplary flow diagram of a method 500 for updating prediction model for curing process design, in accordance with an example embodiment. It will be understood that each block of the flow diagram of the method 500 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 104 of the computing device 102, employing an embodiment of the present disclosure and executed by a processor 106. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

FIG. 5 is explained in conjunction with elements from FIGS. 1, 2, 3, and 4. The method 500 is started at step 502. At step 504, the method 500 may include receiving an input corresponding to a curing process. Upon receiving the input, the method 500, at step 506 may further include identifying a change in material specification.

Further, the method 500, at step 508 may further include generating a first set of experiments through an experiment designer using a predefined design of experiments (DOE) approach, based on the input. The first set of experiments are generated before generating the second set of experiments. Further, the method 500, at step 510 may further include updating the prediction model based on the first set of experiments. The method 500 terminates at step 512.

FIG. 6 illustrates a flow diagram of a method 600 for generating a second set of experiments when the curing coefficients are available, in accordance with an example embodiment. It will be understood that each block of the flow diagram of the method 600 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 104 of the computing device 102, employing an embodiment of the present disclosure and executed by a processor 106. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

FIG. 6 is explained in conjunction with elements from FIGS. 1, 2, 3, 4, and 5. At step 602, the method 600 is initiated. The method 600, at step 604 may include identifying a change in material specification upon receiving the task. his task is handled by the change identification module, which analyzes the input data, including system parameters and the specific design task. The input data often encompasses detailed information about the materials involved in the curing process, such as chemical composition, thermal properties, and physical characteristics. The identification process involves comparing the new material specifications with previously recorded data to detect any changes. Successful identification of material changes is critical for adapting the curing process to new conditions and ensuring that the prediction model remains accurate and relevant.

Further, the method 600, at step 606, may include determining an availability of curing coefficients from material characterization tests when the identification is the successful identification. When the curing coefficients are available, the method 600, at step 608, further include generating the second set of experiments using the curing coefficients through the prediction model and the optimization component The method 600 ends at step 610.

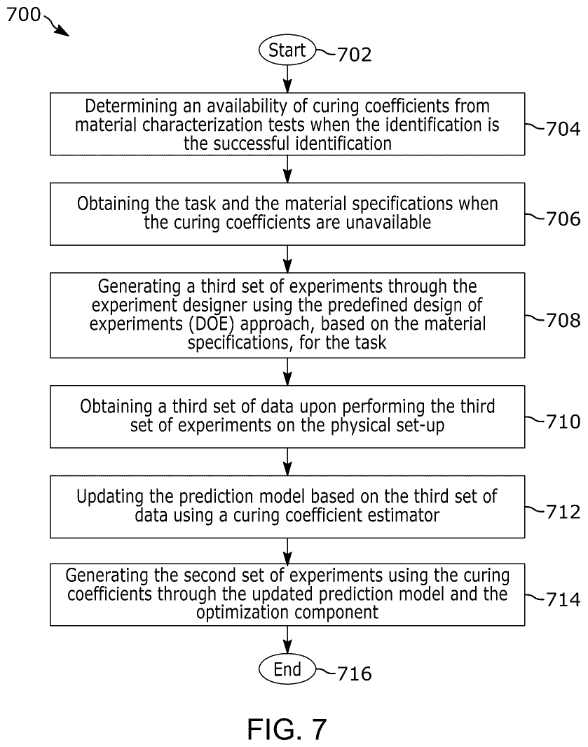

FIG. 7 illustrates a flow diagram of a method 700 for generating a second set of experiments when the curing coefficients are unavailable, in accordance with an example embodiment. It will be understood that each block of the flow diagram of the method 700 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 104 of the computing device 102, employing an embodiment of the present disclosure and executed by a processor 106. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

FIG. 7 is explained in conjunction with elements from FIGS. 1, 2, 3, 4, 5, and 6. At step 702, the method 700 is initiated. The method 700, at step 704 may include determining an availability of curing coefficients from material characterization tests when the identification is the successful identification.

Further, the method 700, at step 706, may include obtaining the task and the material specifications when the curing coefficients are unavailable. The method 700, at step 708, further include generating a third set of experiments through the experiment designer using the predefined DOE approach, based on the material specifications, for the task. The method 700, at step 710, further include obtaining a third set of data upon performing the third set of experiments on the physical set-up.

The method 700, at step 712, further include updating the prediction model based on the third set of data using a curing coefficient estimator. The curing coefficient estimator is configured to estimate material specifications and corresponding behavior. The method 700, at step 714, further include generating the second set of experiments using the curing coefficients through the updated prediction model and the optimization component. The method 700 ends at step 716.

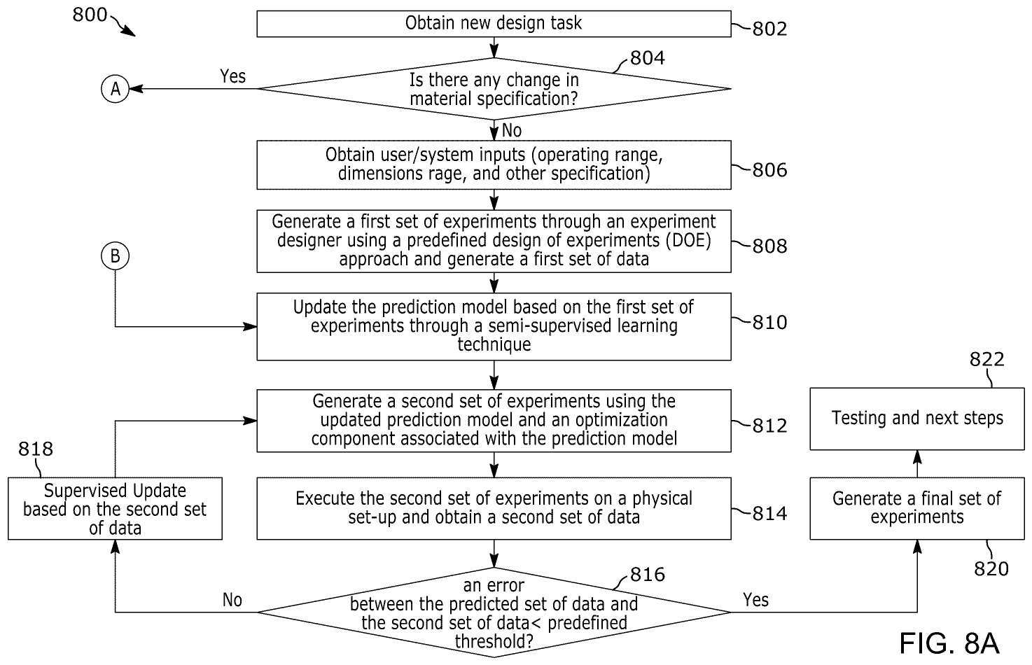

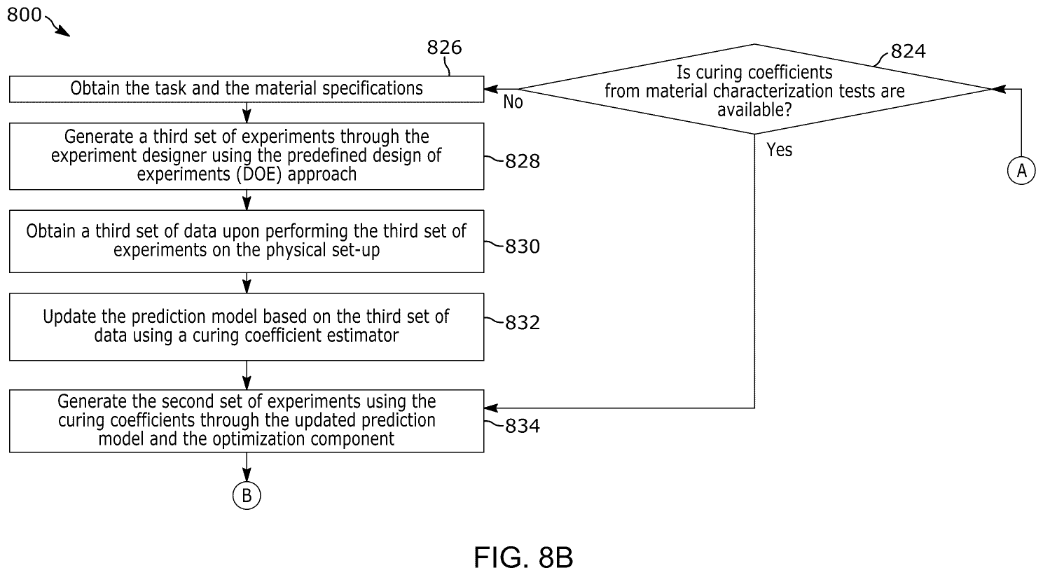

FIGS. 8A and 8B illustrate an exemplary flow chart 800 for updating prediction model for curing process design, in accordance with an example embodiment. Initially, at step 802, new design task is obtained. This is the initial step where a new design task is received. This task includes objectives and constraints for the curing process. The design task typically specifies the goals for the curing process such as optimizing curing degree, enhancing material properties, or achieving uniform curing. It also includes detailed requirements and constraints like material type, mechanical properties, environmental conditions, and industry-specific standards.

At step 804, a check may be performed for material change. This decision point determines whether there is a change in the materials used for the curing process. If the material specifications have changed, it means the curing model and experiments need to be adjusted to account for the new material properties. This decision ensures that the subsequent steps are tailored to the specific materials being used.

At step 806, input system parameters may be obtained. If there is no material change, the system inputs various operational parameters. The input includes operating range, dimensions, material options and other specifications necessary for optimizing the curing process. These parameters help in setting up the conditions under which the curing experiments will be conducted.

At step 808, a first set of experiments may be generated through an experiment designer using a predefined DOE approach. At step 810, a prediction model (e.g., Physics-informed Neural Operator model) may be updated based on the first set of experiments through a semi-supervised learning technique. Further, the first set of experiments are used to generate the first set of data. This is possible because of the Physics-informed Neural Operator model that can learn without any experimental data, only optimizing the weights to follow the known governing equations.

This update is called semi-supervised because it uses only the virtual experiments inputs generated in the earlier step to update the model. This enables the pre-trained model to upgrade itself for the new range of operation, materials, and design conditions. The experiment designer may be instructed to generate ‘n’ virtual curing experiments (VCE) (second set of experiments) such that it assists the model upgrade effectively. The pre-trained model may have been trained on a different design space and this model update may also eliminate some of the extreme inputs which are not required for the current design space (range of materials, operating and design conditions). So, the experiment generator and semi-supervised update assists the model in tuning itself for the current set of design space effectively.

At step 812, a second set of experiments may be generated using the updated prediction model and an optimization component associated with the prediction model. The prediction model, now refined with virtual data, is used to design ‘ml’ second set of experiments that are optimized for achieving the desired curing outcomes. This involves using the optimization component to create experiments that best meet the design task's objectives. These ‘ml’ second set of experiments are conducted in such a way that they explore the full design space in an optimal manner and are not concentrated around a particular area of the design space. This helps better exploration and also better data for the model update later. Curing optimizer may use off-the-shelf optimizers such as evolutionary optimization algorithms for identifying the right set of optimal experiments. Initial experiments could be generated based on design of experiments methods to make sure exploration of the design space is exhaustive.

Initially, when ‘n’ virtual curing (first set) experiments are generated, the experiment designer is set to “explore” the whole search space so as to get the best data for training the model (in a semi-supervised fashion based only on input variations). For any virtual experiment stage (first set of experiments), the experiment designer ensures that the techniques such as Taguchi (or any other design of experiments techniques such as full factorial) are used over the entire potential range of each of the parameters provided by the user. These parameters include aspects, such as, curing cycle temperature regime, oven air flow conditions (that impacts the heat transfer), material options (changing the properties and characteristic curves), design options (dimension of the part). After the semi-supervised update, the curing optimizer generates mᵢ second set of experiments, where “i” is the iteration number. These mᵢ experiments are generated by methods such as Taguchi but restrict the number of experiments below a threshold, as these are expensive to carry out. For example, number of initially virtual first set of experiments could be of the order of 1000s, but mᵢ real second set of experiments should only be restricted to 10-20. For smaller values of “i”, the experiments should be spread across in the “exploration” phase.

As “i” increases (after iterative learning of the model), the experiment generation in next iterations should reduce the search space around where the best results have been obtained and maintain the number of experiments. So as the “i” increases, the experiments suggested by optimizer component becomes more exploitative.

At step 814, the second set of experiments be executed. The second set of experiments are executed on a physical set-up. This step involves conducting the actual curing experiments as planned, using the specified materials and conditions. Data from these experiments, including temperature profiles, pressure readings, and curing times, is collected for further analysis. The collected data may include sensor data, visual observations, and laboratory analysis data. This is the second set of data.

At step 816, the error determination module compares the error between the predicted set of data and the second set of data with the predictions made by the model. If an error is within a predefined acceptable threshold, the model is considered accurate. If not, adjustments are needed.

At step 818, the prediction model is updated (supervised update) based on the second set of data, if there is a significant error. This involves preprocessing and integrating the new data from the experiments back into the prediction model to refine its accuracy. This supervised update ensures that the model may better predict real-world outcomes, making it more reliable for future predictions. The PINO model ensures that model parameters are updated with respect to actual experiments and yet the model follows the physical laws. Steps 812, 814, 816 and 818 may repeat several times until the error between predicted and real experimental values is under a predefined threshold. Each time progressively, the set of experiments may explore a narrower design space per the accuracy of the model and design space where the likely optimum lies.

At step 820, a final set of experiments may be generated, once the prediction model accuracy is satisfactory. Based on the updated and validated model, the final set of experiments is designed. These final experiments aim to confirm the robustness and reliability of the prediction model. The final experiments are crucial for fine-tuning the curing process parameters to ensure optimal performance and quality. The final set of experiments may explore only design space in the vicinity of the optimal suggested by the optimizer. This way the predictive ability of the PINO model can be exploited to find the better optimum setting.

At step 822, the final set of experiments is tested, and further steps are determined based on the results. This involves executing the final experiments and analyzing the outcomes. If the results are satisfactory, the curing process design is validated and finalized and taken to production. If further refinements are needed, additional steps may be taken to adjust the process parameters.

Referring now to FIG. 8B, at step 824, if there are changes in material specifications, the availability of material characterization data is checked. This step determines whether the necessary curing coefficients, derived from characterization tests, are available. These coefficients are essential for accurately modeling the curing process for the new materials.

At step 826, new design task and material specifications may be obtained. At step 828, if material characterization data is not available, a third set of experiments may be generated to estimate these curing coefficients through the experiment designer using the predefined DOE approach. In particular, the curing coefficient estimator, which is a specialized tool for estimating material behavior and specifications, estimates the missing curing coefficients. The system designs and executes ‘a’ new curing experiment to gather data related to curing experiments. This data is used to update the curing prediction model which simultaneously predicts the material properties, ensuring it accurately reflects the behavior of the new materials. PINO model enables estimation of material properties based on a small set of real experimental data and limits the number of expensive material testing procedures.

At steps 830, a third set of data may be obtained upon performing the third set of experiments on the physical set-up. At step 832 the prediction model may be updated based on the third set of data using the curing coefficient estimator. The prediction model is updated with this real-world data, ensuring it can make accurate predictions for the new materials. Finally, at step 834 the second set of experiments may be generated using the curing coefficients through the updated prediction model and the optimization component to ensure the curing process is well-designed for the specific materials.

Overall, the automated experiment generation, optimized curing experiment generation and automated model update to finetune it to current design space reduces the requirement of actual experimentation, reduces the dependence on human expertise and enables faster design development and testing.

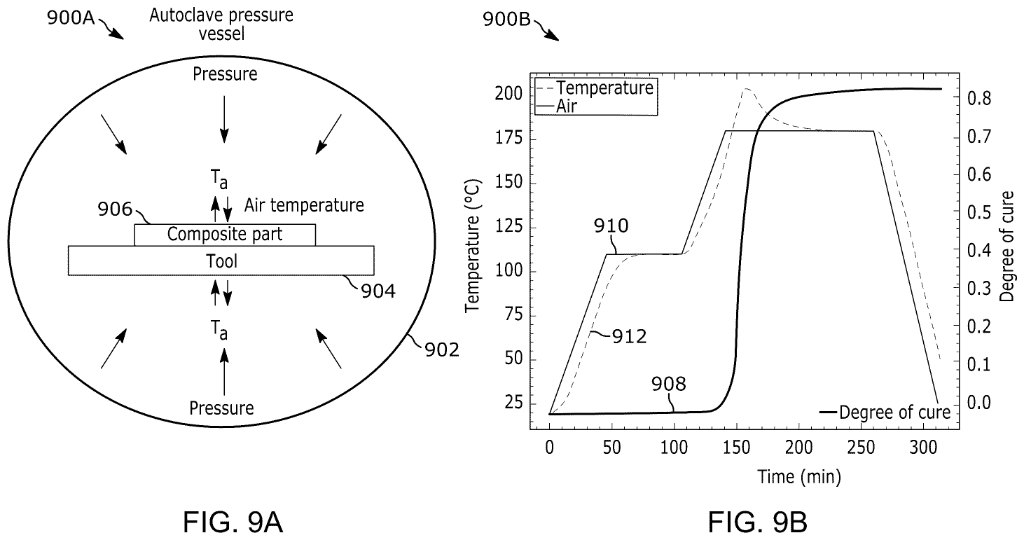

FIG. 9A illustrates an exemplary autoclave setup 900A for composite materials, in accordance with an example embodiment. The present FIG. 9A depicts autoclave pressure vessel setup. The autoclave setup 900A includes an autoclave pressure vessel 902. The autoclave pressure vessel 902 is a controlled environment where the curing process takes place. It is designed to apply both heat and pressure to the composite part to ensure proper curing.

In a more elaborative way, the process begins with an initial heating phase where the temperature inside the autoclave is gradually increased. This phase ensures that the composite material reaches the necessary temperature to start the curing reaction.

After reaching the target temperature, the soak phase maintains a constant temperature for a specified duration. This phase allows the curing reaction to proceed steadily, ensuring uniform curing throughout the composite part.

Following the soak phase, the temperature is gradually decreased in a controlled cooling phase. This prevents thermal stresses and potential warping or cracking in the composite part. Throughout the process, the temperature and pressure inside the autoclave are closely monitored and controlled to adhere to the predefined profiles. Any deviations may be corrected in real-time to ensure optimal curing conditions.

Inside the autoclave 902, a composite part 906 is placed on a tool 904 that supports it during the curing process. The composite part is the material undergoing the curing, typically made from layers of fabric and resin. The autoclave controls air temperature (Ta) around the composite part. The temperature is a critical parameter in the curing process, influencing the chemical reactions that occur within the composite material. The autoclave applies pressure from all directions (as indicated by the arrows). The pressure ensures that the composite layers are compacted properly, removing any air bubbles, and ensuring uniform resin distribution. The present example emphasizes a necessity of precise control and monitoring to achieve the desired material properties in the final composite part.

FIG. 9B illustrates a corresponding temperature and degree of cure profiles 900B over time for the autoclave setup 900A, in accordance with an example embodiment. In particular, the present FIG. 9B depicts dynamic temperature and degree of cure profiles, illustrating how the curing process evolves over time.

The temperature profile 908 represents the air temperature inside the autoclave over time. This profile shows how the temperature is increased, held constant, and then decreased in a controlled manner. The air temperature profile 910 indicates the actual temperature of the air inside the autoclave, which is closely monitored and controlled to follow the desired temperature profile. The degree of cure profile 912 tracks the progress of the curing process over time. The degree of cure is a measure of how completely the resin has polymerized and cross-linked, which is crucial for the final properties of the composite part.

As will be appreciated by those skilled in the art, the techniques described in the various embodiments discussed above are not routine, or conventional, or well understood in the art. The techniques discussed above provide for innovative solutions to address the challenges associated with updating the prediction model for the curing process design. The disclosed techniques offer several advantages over the existing methods:

Automatic and Iterative Update of Hybrid Model: The system iteratively updates the hybrid prediction model by incorporating knowledge-driven experiments and real-world experimental data. This continuous feedback loop ensures that the model remains accurate and reliable over time, adapting to new information as it becomes available. In addition, the updated model enables zero-shot dynamic prediction which accelerates the virtual testing and experimentation.

Physics-Informed Predictions: The prediction model, specifically the PINO model, integrates physics-based principles with data-driven approaches. This combination allows for highly accurate predictions under dynamic conditions, providing valuable insights into how the curing process will evolve based on current and expected parameters.

Adaptation to Noise and Uncertainties: The model adjusts to noise and uncertainties in system parameters, ensuring robust performance even when faced with variable conditions. This adaptability is crucial for maintaining the accuracy of the curing process predictions in real-world scenarios.

Automated optimum experiment generation: The system enables automated generation of both virtual and real curing experiments. The VCE are designed to improve the model and fine-tune it to current design space effectively. Hence, they follow an explorative approach. The CE are designed with a dual purpose of generating optimal data for effective model update and gradually identifying the right design space for optimal curing. Hence, they follow explorative strategy initially and gradually zero in an exploitative strategy once the optimal area of the design space is identified.

Unsupervised and Supervised Updates: The system employs both unsupervised and supervised learning techniques. Unsupervised updates are performed using only the input parameters specific to the generated experiments, without relying on real experimental output data. In contrast, supervised updates are based on data generated and measured from real experiments, ensuring that the model is continuously refined with empirical evidence.

Optimization of Curing Process: The techniques involve generating a second set of experiments using the updated prediction model and an optimization component. The optimization objective is to achieve the best possible curing degree or curve, considering constraints related to physics properties and decision variables such as material composition, dimension, and air temperature. Genetic algorithms or linear programming may be used for this optimization process.

Curing Coefficient Estimation: The predictor model is used for solving the inverse problem, leveraging experimental data and physics principles to estimate curing coefficients. This capability is essential for accurately characterizing material behavior and ensuring that the curing process parameters are correctly set.

Validation and Refinement: The iterative process includes generating multiple sets of experiments (first set, second set, third set, and final set) to validate and refine the prediction model. By comparing predicted outcomes with actual experimental results and adjusting the model accordingly, the system ensures that the final curing process design is both optimized and validated.

Combination of In Vitro and In Vivo Models: The approach combines in vitro (virtual) and in vivo (real) models, providing a comprehensive framework for curing process optimization. This hybrid approach allows for extensive testing and validation, leveraging both simulated and real-world data.

Knowledge-Driven Experimentation: The system generates knowledge-driven experiments that continuously update and improve the model. By designing better experiments based on prior knowledge and real data, the system enhances its predictive capabilities and ensures high-quality outcomes.

Efficient Error Management: The error determination module effectively identifies discrepancies between predicted and actual results, using statistical measures to quantify errors and refine the model. This ensures that the prediction model's performance remains within acceptable thresholds, leading to reliable and accurate curing process designs.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

It is to be understood that the above description is intended to be illustrative, and not restrictive. For example, the above-discussed embodiments may be used in combination with each other. Many other embodiments will be apparent to those of skill in the art upon reviewing the above description.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions, and improvements to the embodiments described above are possible. It is contemplated that these variations, modifications, additions, and improvements fall within the scope of the invention.

We claim:

1. A computer-implemented method for updating prediction model for curing process design, the computer-implemented method comprising:
receiving an input corresponding to a curing process;
updating a prediction model based on the input through a semi-supervised learning technique;
generating a second set of experiments using the updated prediction model and an optimization component associated with the prediction model;
obtaining a second set of data upon performing a second set of experiments on a physical set-up;
determining an error between the predicted set of data and the second set of data; and
updating the prediction model based on the second set of data when the error is out of a predefined threshold, wherein the prediction model is updated iteratively until the error is within the predefined threshold.

2. The computer-implemented method of claim 1, wherein the prediction model is a physics informed neural operator (PINO) model.

3. The computer-implemented method of claim 1, wherein the input comprises a task to design the curing process, and a plurality of system parameters.

4. The computer-implemented method of claim 3, further comprising identifying a change in material specification upon receiving the task, wherein the identification is at least one of a successful identification or an unsuccessful identification.

5. The computer-implemented method of claim 4, further comprising:
when the identification is the unsuccessful identification,
generating the first set of experiments through an experiment designer using a predefined design of experiments (DOE) approach, based on the input, wherein the first set of experiments are generated before generating the second set of experiments; and
updating the prediction model based on the first set of experiments.

6. The computer-implemented method of claim 4, further comprising when the identification is the successful identification, determining an availability of curing coefficients from material characterization tests.

7. The computer-implemented method of claim 6, further comprising, when the curing coefficients are available, generating the second set of experiments using the curing coefficients through the prediction model and the optimization component.

8. The computer-implemented method of claim 6, further comprising:
when the curing coefficients are unavailable,
obtaining the task and the material specifications;
generating a third set of experiments through the experiment designer using the predefined design of experiments (DOE) approach, based on the material specifications, for the task;
obtaining a third set of data upon performing the third set of experiments on the physical set-up;
updating the prediction model based on the third set of data using a curing coefficient estimator, wherein the curing coefficient estimator is configured to estimate material specifications and corresponding behavior; and
generating the second set of experiments using the curing coefficients through the updated prediction model and the optimization component.

9. The computer-implemented method of claim 1, further comprising generating a final set of experiments when the error between the predicted set of data and the second set of data is within the predefined threshold.

10. The computer-implemented method of claim 1, wherein when the error is out of the predefined threshold, the prediction model is further trained to adjust noise and uncertainties in the plurality of system parameters.

11. A computer system for updating prediction model for curing process design, the computer system comprising: one or more computer processors, one or more computer readable memories, one or more computer readable storage devices, and program instructions stored on the one or more computer readable storage devices for execution by the one or more computer processors via the one or more computer readable memories, the program instructions comprising:
receiving an input corresponding to a curing process;
updating a prediction model based on the input through a semi-supervised learning technique;
generating a second set of experiments using the updated prediction model and an optimization component associated with the prediction model;
obtaining a second set of data upon performing a second set of experiments on a physical set-up;
determining an error between the predicted set of data and the second set of data; and
updating the prediction model based on the second set of data when the error is out of a predefined threshold, wherein the prediction model is updated iteratively until the error is within the predefined threshold.

12. The computer-implemented system of claim 11, wherein the prediction model is a physics informed neural operator (PINO) model.

13. The computer-implemented system of claim 11, wherein the input comprises a task to design the curing process, and a plurality of system parameters.

14. The computer-implemented system of claim 13, further comprising identifying a change in material specification upon receiving the task, wherein the identification is at least one of a successful identification or an unsuccessful identification.

15. The computer-implemented system of claim 14, further comprising:
when the identification is the unsuccessful identification,
generating the first set of experiments through an experiment designer using a predefined design of experiments (DOE) approach, based on the input, wherein the first set of experiments are generated before generating the second set of experiments; and
updating the prediction model based on the first set of experiments.

16. The computer-implemented system of claim 14, further comprising when the identification is the successful identification, determining an availability of curing coefficients from material characterization tests.

17. The computer-implemented system of claim 16, further comprising, when the curing coefficients are available, generating the second set of experiments using the curing coefficients through the prediction model and the optimization component.

18. The computer-implemented system of claim 16, further comprising:
when the curing coefficients are unavailable,
obtaining the task and the material specifications;
generating a third set of experiments through the experiment designer using the predefined design of experiments (DOE) approach, based on the material specifications, for the task;
obtaining a third set of data upon performing the third set of experiments on the physical set-up;
updating the prediction model based on the third set of data using a curing coefficient estimator, wherein the curing coefficient estimator is configured to estimate material specifications and corresponding behavior; and
generating the second set of experiments using the curing coefficients through the updated prediction model and the optimization component, wherein the prediction model is updated iteratively until the error is within the predefined threshold.

19. The computer-implemented system of claim 11, further comprising generating a final set of experiments when the error between the predicted set of data and the second set of data is within the predefined threshold.

20. A non-transitory computer-readable storage medium having stored thereon computer executable instruction which when executed by one or more processors, cause the one or more processors to carry out operations for updating prediction model for curing process design, the operations comprising perform the operations comprising:
receiving an input corresponding to a curing process;
updating a prediction model based on the input through a semi-supervised learning technique;
generating a second set of experiments using the updated prediction model and an optimization component associated with the prediction model;
obtaining a second set of data upon performing a second set of experiments on a physical set-up;
determining an error between the predicted set of data and the second set of data; and
updating the prediction model based on the second set of data when the error is out of a predefined threshold, wherein the prediction model is updated iteratively until the error is within the predefined threshold.
